(19) United States
(12) Patent Application Publication
(10) Pub. No.: US 2026/0020072 A1
(43) Pub. Date: Jan. 15, 2026

(54) TECHNIQUES FOR RANDOM ACCESS RESOURCE SELECTION IN WIRELESS COMMUNICATIONS

(71) Applicant: QUALCOMM Incorporated, San Diego, CA (US)

(72) Inventors: Ahmed Attia ABOTABL, San Diego, CA (US); Changhwan PARK, San Diego, CA (US); Hung Dinh LY, San Diego, CA (US)

(21) Appl. No.: 18/771,824

(22) Filed: Jul. 12, 2024

(51) Int. Cl. H04W 74/0833; H04B 17/318; H04W 16/28; H04W 74/08

(52) U.S. Cl. CPC H04W 74/0833; H04B 17/328; H04W 16/28; H04W 74/0866

(57) ABSTRACT

Methods, systems, and devices for wireless communications are described in which a UE may be configured with random access resource selection criteria that can steer the UE to use either a first set of random access resources or a second set of additional random access resources that may be dynamically activated or deactivated. The selection criteria may be a probability that is assigned to each set of resources, and the UE may perform random selection based on a weighting that is given by the probability. Additionally, or alternatively, the selection criteria may include a reference signal receive power (RSRP) associated with the different sets of random access resources, and the second set of random access resources may be selectable by a UE only if a RSRP of a reference signal associated with the second set of random access resources is above a threshold value.

### FIELD OF TECHNOLOGY

The following relates to wireless communications, including techniques for random access resource selection in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period, selecting a first random access channel resource from one of the first set of random access channel resources or the second set of random access channel resources based on the random-access selection information, and transmitting a first random access channel message via the first random access channel resource.

A UE for wireless communications is described. The UE may include one or more memories storing processor executable code, and one or more processors coupled with the one or more memories. The one or more processors may individually or collectively be operable to execute the code to cause the UE to receive random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period, select a first random access channel resource from one of the first set of random access channel resources or the second set of random access channel resources based on the random-access selection information, and transmit a first random access channel message via the first random access channel resource.

Another UE for wireless communications is described. The UE may include means for receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period, means for selecting a first random access channel resource from one of the first set of random access channel resources or the second set of random access channel resources based on the random-access selection information, and means for transmitting a first random access channel message via the first random access channel resource.

A non-transitory computer-readable medium storing code for wireless communications is described. The code may include instructions executable by one or more processors to receive random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period, select a first random access channel resource from one of the first set of random access channel resources or the second set of random access channel resources based on the random-access selection information, and transmit a first random access channel message via the first random access channel resource.

In some examples of the method, UEs, and non-transitory computer-readable medium described herein, the receiving the random access selection information may include operations, features, means, or instructions for receiving a probability associated with the first set of random access channel resources and the second set of random access channel resources, and where the first random access channel resource are selected from the first set of random access channel resources or the second set of random access channel resources based on a random selection that is weighted according to the probability.

In some examples of the method, UEs, and non-transitory computer-readable medium described herein, the receiving the random access selection information may include operations, features, means, or instructions for receiving a first probability associated with the first set of random access channel resources and the second set of random access channel resources for an initial random access channel message transmission and a second probability associated with the first set of random access channel resources and the second set of random access channel resources for a retransmission of the random access channel message, and where, the first random access channel resource is selected for the initial random access channel message transmission from the first set of random access channel resources or the second set of random access channel resources based on a first random selection that is weighted according to the first probability, and a second random access channel resource is selected for the retransmission of the random access channel message from the first set of random access channel resources or the second set of random access channel resources based on a second random selection that is weighted according to the second probability.

In some examples of the method, UEs, and non-transitory computer-readable medium described herein, the receiving the random access selection information may include operations, features, means, or instructions for receiving a first probability associated with a first beam index that is associated with a first subset of the first set of random access channel resources and a second subset of the second set of random access channel resources, receiving a second probability associated with a second beam index that is associated with a third subset of the first set of random access channel resources and a fourth subset of the second set of random access channel resources, and where the first beam index or the second beam index is selected based on a channel measurement of reference signals associated with each beam index, and the respective first probability or second probability is used to determine whether the first random access channel resource is selected from the first set of random access channel resources or the second set of random access channel resources.

In some examples of the method, UEs, and non-transitory computer-readable medium described herein, the receiving the random access selection information may include operations, features, means, or instructions for receiving a first reference signal receive power (RSRP) threshold value associated with the first set of random access channel resources and a second RSRP threshold value associated with the second set of random access channel resources and where the first random access channel resource can be selected from a respective set of random access channel resources when a measured RSRP value is greater than or equal to the RSRP threshold value associated with the respective set of random access channel resources. In some examples of the method, UEs, and non-transitory computer-readable medium described herein, the second RSRP threshold value may be larger than the first RSRP threshold value. In some examples of the method, UEs, and non-transitory computer-readable medium described herein, the first RSRP threshold value may be larger than the second RSRP threshold value.

In some examples of the method, UEs, and non-transitory computer-readable medium described herein, the receiving the random access selection information may include operations, features, means, or instructions for receiving a probability value associated with the first set of random access channel resources and the second set of random access channel resources, receiving a reference signal receive power (RSRP) threshold value associated with the second set of random access channel resources, adjusting the RSRP threshold value based on the probability value to generate an adjusted RSRP threshold value, and where the first random access channel resource is selected from the second set of random access channel resources based on a measured RSRP value being greater than or equal to the adjusted RSRP threshold value.

In some examples of the method, UEs, and non-transitory computer-readable medium described herein, the random access selection information is received in one or more of system information, radio resource control information, or signaling that configures the second set of random access channel resources and that indicates one or more specified selection parameters. In some examples of the method, UEs, and non-transitory computer-readable medium described herein, the random access selection information may be received in a downlink control information transmission that activates the second set of random access channel resources. In some examples of the method, UEs, and non-transitory computer-readable medium described herein, the random access selection information includes a set of bits that indicate at least a first parameter of the one or more parameters for random access channel resource selection, and where the first parameter may be indicated through a direct mapping to a real number by quantization over a maximum possible value of the first parameter, or through a mapping between different bit values and different values of the first parameter.

In some examples of the method, UEs, and non-transitory computer-readable medium described herein, the first random access channel resource is associated with a first subset of random access occasions of the second set of random access channel resources and the method, apparatuses, and non-transitory computer-readable medium may include further operations, features, means, or instructions for determining that a random access occasion of the first subset of random access occasions is not present within a first association period during which the first SSB is associated with the first subset of random access occasions and deferring transmission of the first random access channel message until a subsequent association period that does include a random access occasion of the first subset of random access occasions, or transmitting the first random access channel message in a random access channel resource of the first set of random access channel resources.

A method for wireless communications by a network entity is described. The method may include determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period, outputting the random access selection information for transmission to one or more UEs, and obtaining one or more random access channel messages via one or more of the first set of random access channel resources and the second set of random access channel resources.

A network entity for wireless communications is described. The network entity may include one or more memories storing processor executable code, and one or more processors coupled with the one or more memories. The one or more processors may individually or collectively be operable to execute the code to cause the network entity to determine random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period, output the random access selection information for transmission to one or more UEs, and obtain one or more random access channel messages via one or more of the first set of random access channel resources and the second set of random access channel resources.

Another network entity for wireless communications is described. The network entity may include means for determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period, means for outputting the random access selection information for transmission to one or more UEs, and means for obtaining one or more random access channel messages via one or more of the first set of random access channel resources and the second set of random access channel resources.

A non-transitory computer-readable medium storing code for wireless communications is described. The code may include instructions executable by one or more processors to determine random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period, output the random access selection information for transmission to one or more UEs, and obtain one or more random access channel messages via one or more of the first set of random access channel resources and the second set of random access channel resources.

In some examples of the method, network entities, and non-transitory computer-readable medium described herein, the determining the random access selection information may include operations, features, means, or instructions for determining a probability associated with the first set of random access channel resources and the second set of random access channel resources, and where the first random access channel resource is configured to be selected from the first set of random access channel resources or the second set of random access channel resources based on a random selection that is weighted according to the probability.

In some examples of the method, network entities, and non-transitory computer-readable medium described herein, the determining the random access selection information may include operations, features, means, or instructions for determining a first probability associated with the first set of random access channel resources and the second set of random access channel resources for an initial random access channel message transmission and a second probability associated with the first set of random access channel resources and the second set of random access channel resources for a retransmission of the random access channel message, and where, the first random access channel resource is configured to be selected for the initial random access channel message transmission from the first set of random access channel resources or the second set of random access channel resources based on a first random selection that is weighted according to the first probability, and a second random access channel resource is configured to be selected for the retransmission of the random access channel message from the first set of random access channel resources or the second set of random access channel resources based on a second random selection that is weighted according to the second probability.

In some examples of the method, network entities, and non-transitory computer-readable medium described herein, the determining the random access selection information may include operations, features, means, or instructions for determining a first probability associated with a first beam index that is associated with a first subset of the first set of random access channel resources and a second subset of the second set of random access channel resources, determining a second probability associated with a second beam index that is associated with a third subset of the first set of random access channel resources and a fourth subset of the second set of random access channel resources, and where the first beam index or the second beam index is configured to be selected based on a channel measurement of reference signals associated with each beam index, and the respective first probability or second probability is used to determine whether the first random access channel resource is selected from the first set of random access channel resources or the second set of random access channel resources.

In some examples of the method, network entities, and non-transitory computer-readable medium described herein, the determining the random access selection information may include operations, features, means, or instructions for determining a first reference signal receive power (RSRP) threshold value associated with the first set of random access channel resources and a second RSRP threshold value associated with the second set of random access channel resources and where the first random access channel resource is configured to be selected from a respective set of random access channel resources when a measured RSRP value is greater than or equal to the RSRP threshold value associated with the respective set of random access channel resources. In some examples of the method, network entities, and non-transitory computer-readable medium described herein, the second RSRP threshold value may be larger than the first RSRP threshold value. In some examples of the method, network entities, and non-transitory computer-readable medium described herein, the first RSRP threshold value may be larger than the second RSRP threshold value.

In some examples of the method, network entities, and non-transitory computer-readable medium described herein, the determining the random access selection information may include operations, features, means, or instructions for determining a probability value associated with the first set of random access channel resources and the second set of random access channel resources, determining a reference signal receive power (RSRP) threshold value associated with the second set of random access channel resources, configuring the RSRP threshold value to be adjusted based on the probability value to generate an adjusted RSRP threshold value, and where the first random access channel resource is configured to be selected from the second set of random access channel resources based on a measured RSRP value being greater than or equal to the adjusted RSRP threshold value.

In some examples of the method, network entities, and non-transitory computer-readable medium described herein, the random access selection information is transmitted in one or more of system information, radio resource control information, or signaling that configures the second set of random access channel resources and that indicates one or more specified selection parameters. In some examples of the method, network entities, and non-transitory computer-readable medium described herein, the random access selection information may be transmitted in a downlink control information transmission that activates the second set of random access channel resources. In some examples of the method, network entities, and non-transitory computer-readable medium described herein, the random access selection information includes a set of bits that indicate at least a first parameter for random access channel resource selection, and where the first parameter may be indicated through a direct mapping to a real number by quantization over a maximum possible value of the first parameter, or through a mapping between different bit values and different values of the first parameter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for random access resource selection in wireless communications in accordance with one or more aspects of the present disclosure.

FIG. 2 shows an example of a wireless communications system that supports techniques for random access resource selection in wireless communications in accordance with one or more aspects of the present disclosure.

FIG. 3 shows an example of a resource diagram that supports techniques for random access resource selection in wireless communications in accordance with one or more aspects of the present disclosure.

FIG. 4 shows an example of a resource diagram that supports techniques for random access resource selection in wireless communications in accordance with one or more aspects of the present disclosure.

FIG. 5 shows an example of a process flow that supports techniques for random access resource selection in wireless communications in accordance with one or more aspects of the present disclosure.

FIGS. 6 and 7 show block diagrams of devices that support techniques for random access resource selection in wireless communications in accordance with one or more aspects of the present disclosure.

FIG. 8 shows a block diagram of a communications manager that supports techniques for random access resource selection in wireless communications in accordance with one or more aspects of the present disclosure.

FIG. 9 shows a diagram of a system including a device that supports techniques for random access resource selection in wireless communications in accordance with one or more aspects of the present disclosure.

FIGS. 10 and 11 show block diagrams of devices that support techniques for random access resource selection in wireless communications in accordance with one or more aspects of the present disclosure.

FIG. 12 shows a block diagram of a communications manager that supports techniques for random access resource selection in wireless communications in accordance with one or more aspects of the present disclosure.

FIG. 13 shows a diagram of a system including a device that supports techniques for random access resource selection in wireless communications in accordance with one or more aspects of the present disclosure.

FIGS. 14 and 15 show flowcharts illustrating methods that support techniques for random access resource selection in wireless communications in accordance with one or more aspects of the present disclosure.

### DETAILED DESCRIPTION

In some wireless communications systems, one or more network components (e.g., network entities such as transmission-reception points (TRPs), radio heads, radio units, base stations, gNodeBs, and the like) may perform network energy savings (NES) techniques that may reduce energy consumption of the network. Various user equipment (UE) energy reduction techniques have been employed to help provide for longer battery life, and various energy reduction techniques are being investigated on the network side to help reduce overall network power consumption. One NES technique is a reduction in physical random access channel (PRACH) resources (which may also be referred to as random access channel (RACH) resources) that are monitored at the network. Such techniques may allow a network entity to dynamically adjust a quantity of available RACH resources based on network conditions, which may reduce a quantity of RACH resources that are to be monitored for some periods and reduce network power consumption. In some cases, such techniques may provide a first set of RACH resources that are always available, and usable by UEs that are not capable of adjusting available RACH resources (which may be referred to as legacy UEs), and a second set of RACH resources that may be available when indicated by the network entity.

As indicated, RACH resources of the second set may be usable only be UEs that are capable of adjusting available RACH resources that are used for selection of a PRACH resource for a random access channel transmission. Further, for UEs that are compatible with dynamic availability of RACH resources, it may be useful to use either the first set of RACH resources (which may be referred to as legacy RACH resources) or additional RACH resources. Thus, techniques for signaling availability of some RACH resources, such as RACH resources of the second set of RACH resources (or one or more additional sets of RACH resources) may be allow for efficient deployment of NES techniques and also provide additional flexibility and network management techniques (e.g., steering of UEs to use different RACH resources based on a proximity to a network entity).

In accordance with various aspects, a UE may be configured with RACH resource selection criteria that can steer the UE to use either legacy RACH resources (e.g., a first set of RACH resources) or additional RACH resources that may be dynamically activated or deactivated (e.g., a second set of RACH resources). In some aspects, the selection criteria may be a probability that is assigned to each set of resources, and the UE may perform random selection based on a weighting that is given by the probability. For example, if a probability of 0.1 is assigned to legacy RACH resources, the random selection may be weighted to provide that a resource from the legacy RACH resources is selected 10% of the time and that a resource from the additional RACH resources is selected 90% of the time.

In some aspects, the selection criteria may include a reference signal received power (RSRP) associated with the different sets of RACH resources. For example, additional RACH resources may be selectable by a UE only if a RSRP of a synchronization signal block (SSB) reference signal associated with the additional RACH resources is above a first threshold value, which may be higher than a second threshold value for selection of a legacy RACH resource. Such an RSRP-based selection may provide that UEs that are closer to a center of a cell use the additional RACH resources and UEs that are closer to the cell edge use legacy RACH resources. In further aspects, a combination of RSRP and probabilities may be used. In aspects where probabilities are used, there may also be different probabilities associated with different beam indices associated with different SSBs, or different probabilities for an initial transmission versus a retransmission of a random access message.

Such techniques may allow for selection of additional RACH resources by UEs that are capable of using such resources, while providing a baseline or legacy set of RACH resources that are available for UEs that do not have such capability. Such techniques thus allow for power reduction techniques to be implemented by the network, as well as steering of UEs to use different RACH resources, which may enhance network flexibility and management of RACH resources, reduce latency associated with random access messages, and enhance network reliability.

Aspects of the disclosure are initially described in the context of wireless communications systems. Aspects of the disclosure are further illustrated by and described with reference to resource diagrams, process flows, apparatus diagrams, system diagrams, and flowcharts that relate to techniques for random access resource selection in wireless communications.

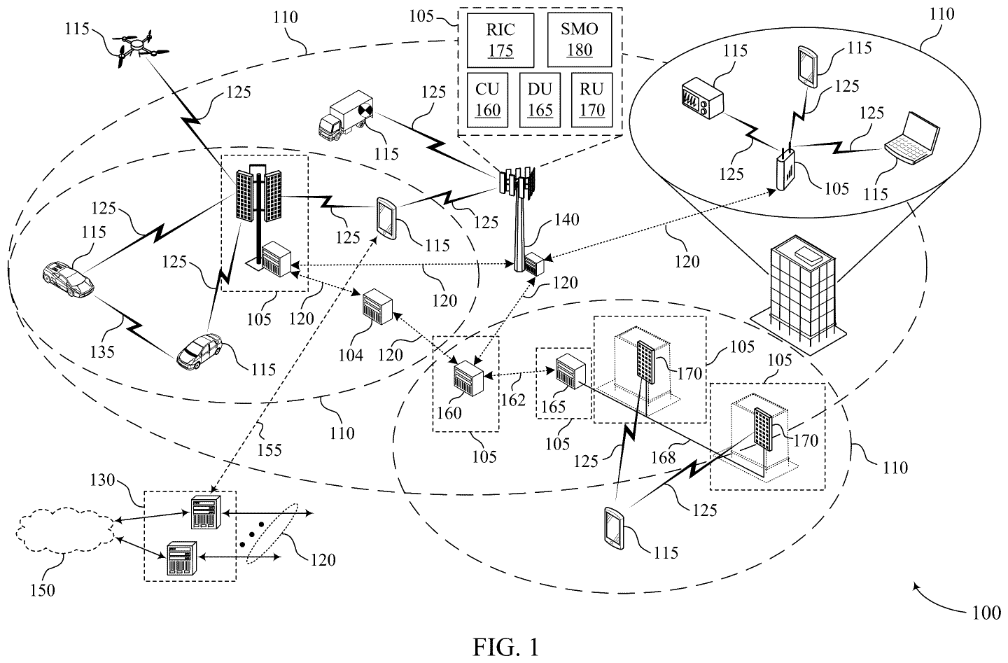

FIG. 1 shows an example of a wireless communications system 100 that supports techniques for random access resource selection in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, a UE 115 may be configured with RACH resource selection criteria that can steer the UE 115 to use either legacy RACH resources (e.g., a first set of RACH resources) or additional RACH resources that may be dynamically activated or deactivated in addition to the legacy RACH resources (e.g., a second set of RACH resources). In some aspects, the selection criteria may be a probability that is assigned to each set of resources, and the UE 115 may perform random selection based on a weighting that is given by the probability. In some aspects, the selection criteria may include a RSRP associated with the different sets of RACH resources, and the additional RACH resources may be selectable by a UE 115 only if a RSRP of a SSB reference signal associated with the additional RACH resources is above a threshold value.

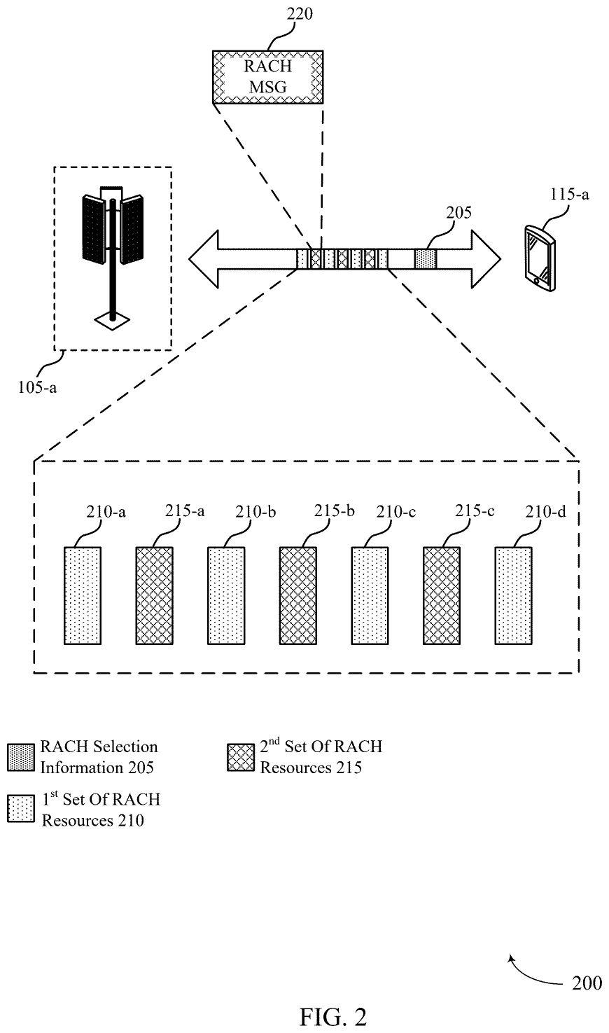

FIG. 2 shows an example of a wireless communications system 200 that supports techniques for random access resource selection in wireless communications in accordance with one or more aspects of the present disclosure. For example, the wireless communications system 200 may include one or more UEs 115 (e.g., a UE 115-a) and one or more network entities 105 (e.g., a network entity 105-a), which may be examples of the corresponding devices as described herein.

In this example, the network entity 105-a may transmit RACH selection information 205 (e.g., in one or more SSBs, one or more control resource set (CORESET) transmissions, one or more downlink control information (DCI transmissions, activation signaling for dynamically activated RACH occasions, or any combination thereof). The RACH selection information 205 may indicate, in some cases, a first set of RACH resources 210 and a second set of RACH resources 215 that may be used for transmission of a RACH message 220 (e.g., a RACH preamble). For example, the first set of RACH resources 210 may include multiple resources, including a first RACH resource 210-a, a second RACH resource 210-b, a third RACH resource 210-c, and a fourth RACH resource 210-d, and the second set of RACH resource 215 may include multiple resources, including fifth RACH resource 215-a, sixth RACH resource 215-b, and seventh RACH resource 215-c.

As discussed herein, in some aspects the second set of RACH resource 215 may be dynamically turned on and off as part of network energy savings techniques at the network entity 105-a. NES-capable UEs 115, such as UE 115-a, can use both the first set of RACH resources 210 and the second set of RACH resources 215, while a non-NES capable UE 115 may use only the first set of RACH resources 210. In some aspects, for the additional RACH resources of the second set of RACH resources 215, the network entity 105-a may perform adaptation of the resource periodicity or RACH occasion, such as through adaptation at the RACH configuration, association period, association pattern period level, at the SSB to RO mapping cycle, based on extending cell discontinuous reception (DRX) operation for RACH resources, or any combinations thereof. In some cases, RACH occasions (ROs) may be concentrated in the time domain through such adaptation.

In some aspects, network energy saving may be provided by starting with a relatively sparse RACH configuration (e.g., with a smaller number of PRACH resources) that includes the first set of RACH resources 210, and additional RACH resource may be activated as needed by activating the second set of RACH resources 215. In some cases, the second set of RACH resources 215 may be activated based on network activity (e.g., based on UE 115 connections, collision reports, other network information, or any combination thereof).

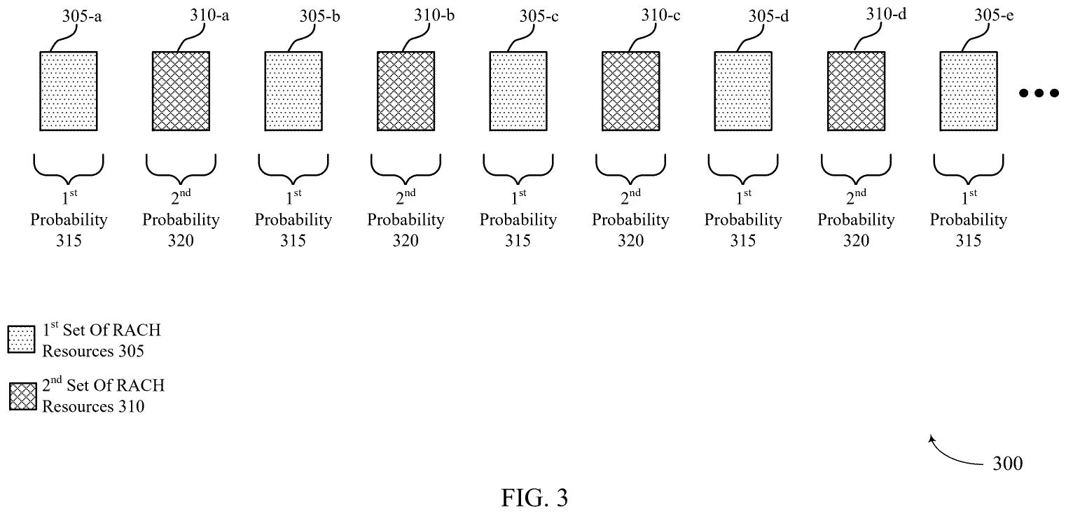

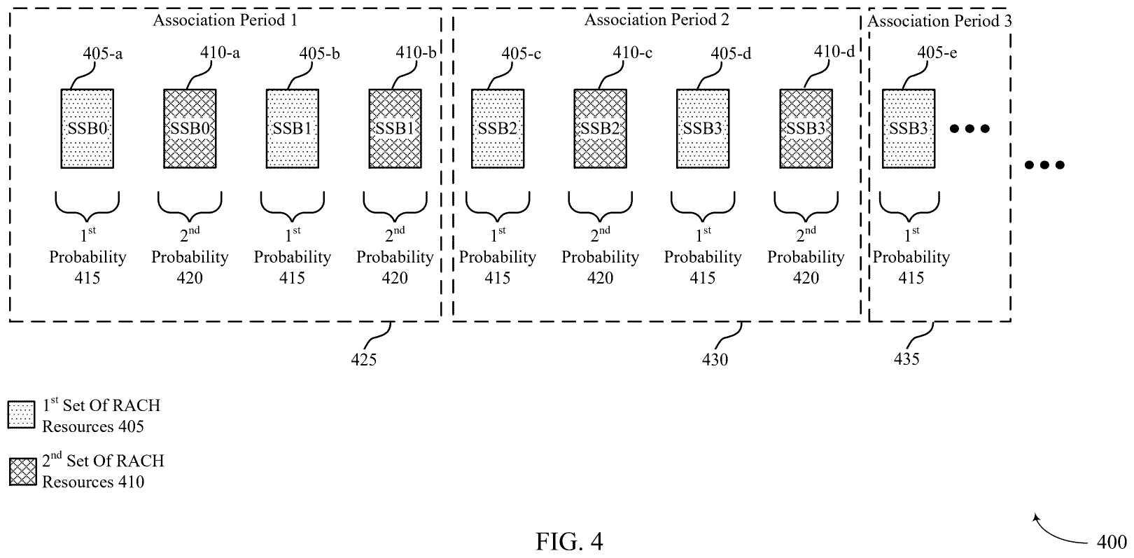

In accordance with various aspects discussed herein, the UE 115-a may select a RACH resource from one of the first set of RACH resources 210 or the second set of RACH resources 215. In some cases, it may be advantageous to steer the UE 115-a selection of a RACH resource. For example, if the network entity 105-a is not serving many UEs 115 that are capable of using the second set of RACH resources 215, then it may be preferable for all such UEs 115 to use the second set of RACH resources 215. In other examples, if a relatively large quantity of UEs 115 are capable of using the second set of RACH resources 215, it may be beneficial to spread their RACH resources across both the first set of RACH resources 210 and the second set of RACH resources 215. In accordance with various techniques, access to the first set of RACH resources 210 and the second set of RACH resources 215 may be regulated using a probabilistic approach. FIGS. 3 and 4 show examples of RACH resources that may be selected in accordance with various techniques as discussed herein.

FIG. 3 shows an example of a resource diagram 300 that supports techniques for random access resource selection in wireless communications in accordance with one or more aspects of the present disclosure. In some cases, the resource diagram 300 may implement or be implemented by aspects of the wireless communications system 100, wireless communications system 200, or both. For example, the resource diagram 300 may be implemented by one or more UEs 115 and one or more network entities 105, which may be examples of the corresponding devices as described herein.

As described herein, with reference to FIG. 2, a UE 115 may support selection of RACH resources from a RACH resource set of two or more available RACH resource sets. In the example of FIG. 3, a first set of RACH resources 305 (including RACH resources 305-a through 305-c) and a second set of RACH resources 310 (including RACH resources 310-a through 310-d) are available for transmission of RACH messages, with the second set of RACH resources 310 being dynamically configurable by a network entity. In some aspects, the network entity may indicate a probability of using a RACH resource of the second set of RACH resources 310, such that the first set of RACH resources 305 are associated with a first probability 315 and the second set of RACH resources are associated with a second probability 320. In some cases, RACH occasions in each of the different sets of RACH resources may be associated with a SSB index, such that if a UE selects a particular SSB as having favorable channel characteristics, RACH messages may be transmitted in RACH occasions associated with the selected SSB index. In some cases, the network entity may indicate a probability (p) associated with the second set of RACH resources 310, such that if p=0 a UE having a capability to use the second set of RACH resources 310 is not allowed to use the second set of RACH resources 310. Likewise, if p=1, the UE will use only a RACH resource of the second set of RACH resources 310, and the value of p may be selected to be between 0 and 1 to steer the likelihood of selection is desired by the network entity.

In some aspects, the network entity may indicate a probability for each retransmission attempt of a RACH message, such that retransmissions may have a different likelihood of using the second set of RACH resources 310 than an initial transmission. For example, the network entity may indicate multiple probability values (e.g., P1, P2, . . . ), where P1 is the probability of selecting a RACH resource from the second set of RACH resources 310 in the first transmission and, if failed, P2 is the probability of selecting a RACH resource from the second set of RACH resources 310 in the second transmission, and so on. Additionally, or alternatively, the network entity may indicate a probability for each beam index (e.g., P(1), P(2), . . . ), where P(1) is the probability that the UE transmits a random access message associated to SSB index 1 from the second set of RACH resources 310, and so on. In further aspects, additionally, or alternatively, a RSRP threshold may be associated with the first set of RACH resources 305 and the second set of RACH resources 310. In such cases, the UE may select a RACH resource from the corresponding set of resources if the RSRP associated with an SSB or other reference signal that corresponds to the RACH occasion meets the RSRP threshold. In such a manner, a network entity may steer UEs within a particular proximity of a cell center to use different resource sets (e.g., a higher RSRP may be associated with the second set of RACH resources 310, such that UEs closer to cell center are more likely to use the second set of RACH resources 310, and UEs near the cell edge are more likely to use the first set of RACH resources 305). In some aspects, one or more RSRP thresholds may be combined with a probability by generating a new RSRP threshold from the indicated probability.

In some aspects, as discussed, a probability may be provided for selection of the second set of RACH resources 310. In such aspects, the probability in theory is a real number between 0 and 1. However, in order to provide efficient signaling of the associated probability, the probability value may be quantized, and an indication of the quantized probability may be provided to one or more UEs (e.g., via system information such as SIB1, RRC signaling, DCI, MAC control element, or any combination thereof). In some cases, quantized probability levels may be hard coded at the network and UEs. In some cases, the probability value may be indicated along with an activation indication that activates or changes a periodicity of the second set of RACH resources 310. For example, if an activation indication is provided in downlink control information (DCI), it may also indicate the probability. In other cases, if a DCI only indicates the activation, a paging DCI or associated data payload may carry the probability indication. In some cases, the indication of the probability may be provided in a set of bits, where a quantity of bits would translate to a value of the probability through either a direct mapping to a real number by quantization over the maximum possible value or an index value to a predefined table.

In cases where one or more RSRP thresholds value are provided, identifying a new RSRP-threshold for the second set of RACH resources 310 can act as a motivation for the UE for selection. For example, if the RSRP threshold is higher for the second set of RACH resources 310 than the first set of RACH resources 305, this case gives a higher likelihood that a UE will use the first set of RACH resources 305 compared to the second set of RACH resources 310. Likewise, if the RSRP is lower for the second set of RACH resources 310 than the first set of RACH resources 305, this case gives a lower likelihood that the UE will use the first set of RACH resources 305 compared to the second set of RACH resources 310.

As discussed, in some aspects, RACH occasions associated with the second set of RACH resources 310 may have a RSRP-threshold that is derived from an indicated probability. For example, at P=0.5, the likelihood of using RACH occasions may be equal for the first set of RACH resources 305 and the second set of RACH resources 310 (e.g., P=0.5, additional_ROs_RSRP_threshold=Legacy_RSRP_threshold), and a general equation may be:

$$additionalRORSRPThreshold = LegacyRSRPThreshold + α ( P - 0.5 ) ;$$

where α is a parameter that indicates how fast the RSRP threshold adapts with the probability, and may be indicated in system information or RRC signaling, or in the activation indication that activates the second set of RACH resources 310.

FIG. 4 shows an example of a resource diagram 400 that supports techniques for random access resource selection in wireless communications in accordance with one or more aspects of the present disclosure. In some cases, the resource diagram 400 may implement or be implemented by aspects of the wireless communications system 100, wireless communications system 200, or both. For example, the resource diagram 400 may be implemented by one or more UEs 115 and one or more network entities 105, which may be examples of the corresponding devices as described herein.

As described herein, with reference to FIGS. 2 and 3, a UE 115 may support selection of RACH resources from a RACH resource set of two or more available RACH resource sets. In the example of FIG. 4, a first set of RACH resources 405 (including RACH resources 405-a through 405-e) and a second set of RACH resources 410 (including RACH resources 410-a through 410-d) are available for transmission of RACH messages, with the second set of RACH resources 410 being dynamically configurable by a network entity. In some aspects, the network entity may indicate a probability of using a RACH resource of the second set of RACH resources 410, such that the first set of RACH resources 405 are associated with a first probability 415 and the second set of RACH resources are associated with a second probability 420. Further, in this example, RACH occasions and RACH occasion patterns may be configured in a PRACH configuration, that provide patterns of RACH occasions within RACH association periods, including first RACH association period 425, second RACH association period 430, and third RACH association period 435, that are defined within a PRACH association pattern period. In some cases, in a given association period such a first RACH association period 425, there may not be a RACH occasion that maps to a SSB that the UE selected for a RACH transmission (e.g., if the UE selected SSB2 for RACH transmission). In cases where the probability of selection from the second set of RACH resources 410 is greater than zero, and the UE performs the random selection, if the selection is for a RACH occasion from the second set of RACH resources 410, then: (Option 1) the UE may wait for the next association period with an available RACH occasion from the second set of RACH resources 410 to perform the RACH transmission (e.g., limited to a maximum number of association periods), or (Option 2) the UE may drop the selection result and send from the baseline RACH occasions of the first set of RACH resources 405 in the first RACH association period 425.

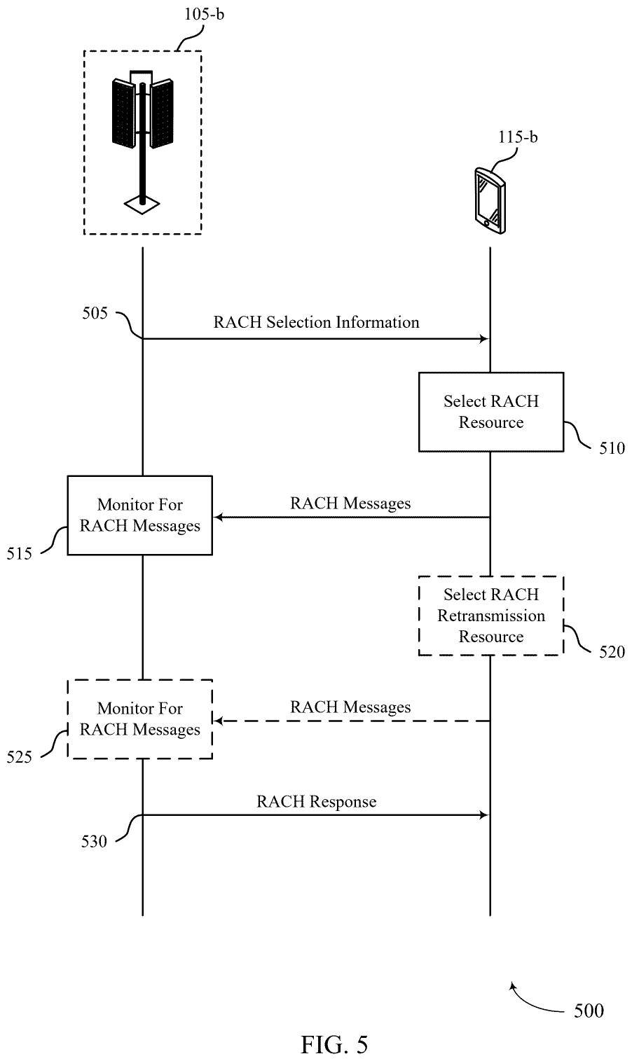

FIG. 5 shows an example of a process flow 500 that supports techniques for random access resource selection in wireless communications in accordance with one or more aspects of the present disclosure. In some cases, the process flow 500 may implement or be implemented by aspects of the wireless communications system 100, the wireless communications system 200, the resource diagram 300, the resource diagram 400, or any combination thereof. For example, the process flow 500 may include one or more UEs 115 (e.g., a UE 115-b) and one or more network entities 105 (e.g., a network entity 105-b), which may be examples of the corresponding devices as described herein. In the following description of the process flow 500, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 500, and other operations may be added to the process flow 500.

At 505, the network entity 105-b may transmit, and the UE 115-b may receive, RACH selection information (which may be an example of random access selection information). As discussed herein, the RACH selection information may indicate one or more parameters for one or more sets of RACH resources that are available for the UE 115-b to select for transmission of a RACH message. In accordance with aspects discussed herein, the one or more sets of RACH resources may include one or more sets of resources that may be dynamically configured, and the UE 115-b may select from the configured sets of resources based at least in part on a probability associated with the sets of resources, a reference signal threshold associated with the sets of resources, or any combinations thereof. In some cases, the RACH selection information may include an indication of one or more of a probability value or reference signal threshold value. The RACH selection information may be transmitted via system information, RRC signaling, DCI, a MAC control element, or any combination thereof.

At 510, the UE 115-b may determine that a random access message is to be transmitted, and may select a RACH resource for transmission of the random access message. The selection of the RACH resource may be performed in accordance with various techniques as discussed herein.

At 515, the UE 115-b may transmit the RACH message, and the network entity 105-b may monitor for the RACH message. As discussed herein, the RACH message may be transmitted using a RACH occasion in the selected RACH resources from a set of RACH resources of two or more available sets of RACH resources.

In some cases, the network entity 105-b may not successfully receive the RACH message from the UE 115-b. In such cases, the network entity 105-b may not transmit a random access response, and the UE 115-b may determine to retransmit the RACH message (e.g., according to an open loop power control procedure that increases RACH message transmission power for retransmissions of a RACH message. At 520, in cases where a retransmission of the RACH message is to be transmitted, the UE 115-b may select a RACH transmission resource. The RACH transmission resource for such a retransmission may be selected in accordance with the various techniques as discussed herein. At 525, the UE 115-b may transmit, and the network entity 105-b may monitor for, the RACH message. At 530, the network entity 105-b may transmit, and the UE 115-b may receive, a RACH response to the transmitted or retransmitted RACH message.

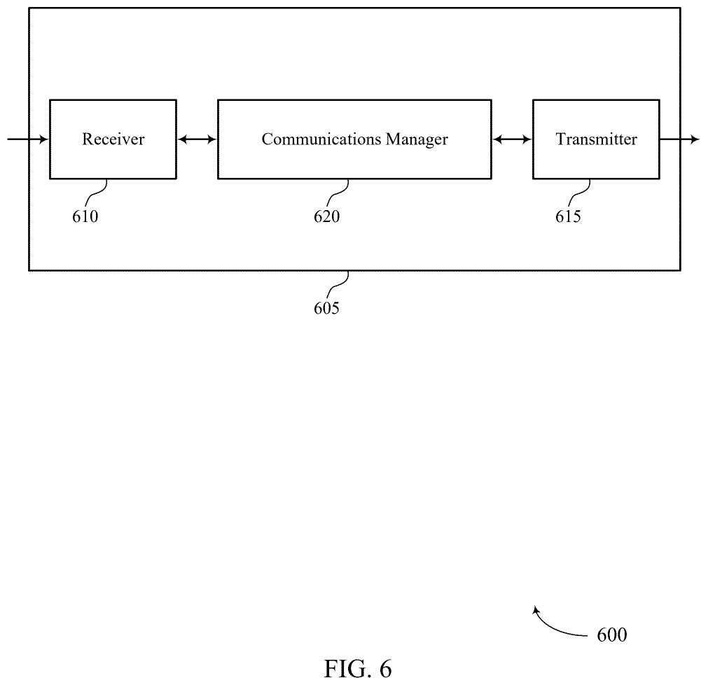

FIG. 6 shows a block diagram 600 of a device 605 that supports techniques for random access resource selection in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for random access resource selection in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for random access resource selection in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for random access resource selection in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period. The communications manager 620 is capable of, configured to, or operable to support a means for selecting a first random access channel resource from one of the first set of random access channel resources or the second set of random access channel resources based on the random-access selection information. The communications manager 620 is capable of, configured to, or operable to support a means for transmitting a first random access channel message via the first random access channel resource.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for selection of additional RACH resources by UEs that are capable of using such resources, while providing a baseline or legacy set of RACH resources that are available for UEs that do not have such capability. Such techniques may allow for power reduction techniques to be implemented by the network, as well as steering of UEs to use different RACH resources, which may enhance network flexibility and management of RACH resources, reduce latency associated with random access messages, and enhance network reliability.

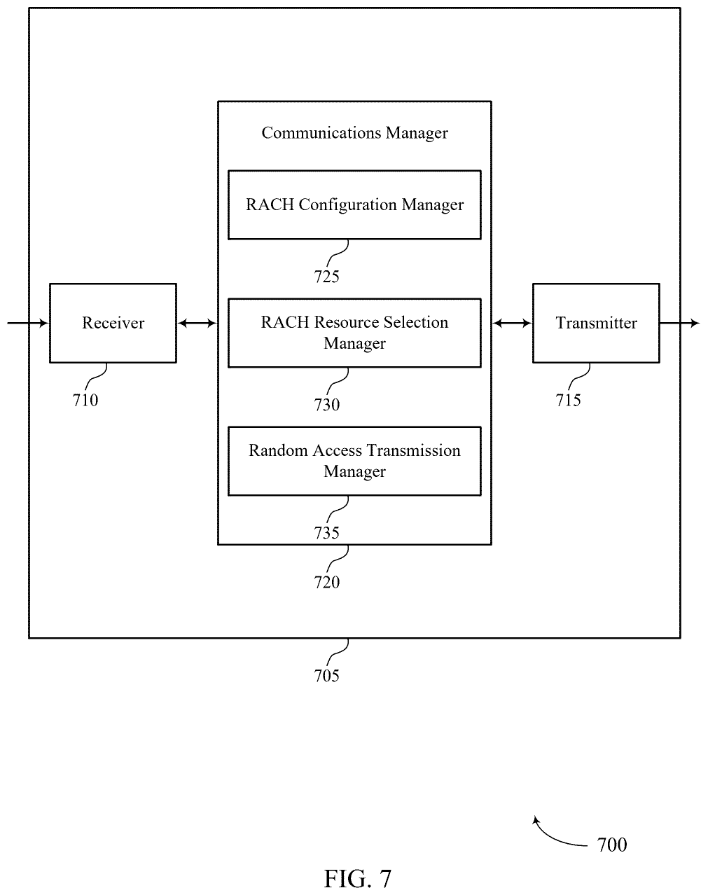

FIG. 7 shows a block diagram 700 of a device 705 that supports techniques for random access resource selection in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for random access resource selection in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for random access resource selection in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for random access resource selection in wireless communications as described herein. For example, the communications manager 720 may include a RACH configuration manager 725, a RACH resource selection manager 730, a random access transmission manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The RACH configuration manager 725 is capable of, configured to, or operable to support a means for receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period. The RACH resource selection manager 730 is capable of, configured to, or operable to support a means for selecting a first random access channel resource from one of the first set of random access channel resources or the second set of random access channel resources based on the random-access selection information. The random access transmission manager 735 is capable of, configured to, or operable to support a means for transmitting a first random access channel message via the first random access channel resource.

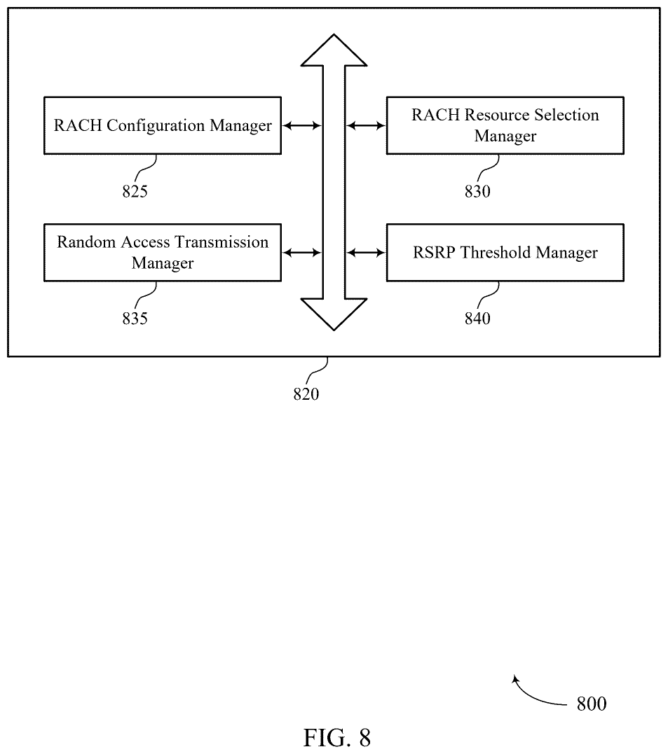

FIG. 8 shows a block diagram 800 of a communications manager 820 that supports techniques for random access resource selection in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for random access resource selection in wireless communications as described herein. For example, the communications manager 820 may include a RACH configuration manager 825, a RACH resource selection manager 830, a random access transmission manager 835, an RSRP threshold manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The RACH configuration manager 825 is capable of, configured to, or operable to support a means for receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period. The RACH resource selection manager 830 is capable of, configured to, or operable to support a means for selecting a first random access channel resource from one of the first set of random access channel resources or the second set of random access channel resources based on the random-access selection information. The random access transmission manager 835 is capable of, configured to, or operable to support a means for transmitting a first random access channel message via the first random access channel resource.

In some examples, to support receiving the random access selection information, the RACH resource selection manager 830 is capable of, configured to, or operable to support a means for receiving a probability associated with the first set of random access channel resources and the second set of random access channel resources, and where the first random access channel resource is selected from the first set of random access channel resources or the second set of random access channel resources based on a random selection that is weighted according to the probability.

In some examples, to support receiving the random access selection information, the RACH configuration manager 825 is capable of, configured to, or operable to support a means for receiving a first probability associated with the first set of random access channel resources and the second set of random access channel resources for an initial random access channel message transmission and a second probability associated with the first set of random access channel resources and the second set of random access channel resources for a retransmission of the random access channel message, and where. In some examples, to support receiving the random access selection information, the RACH resource selection manager 830 is capable of, configured to, or operable to support a means for the first random access channel resource is selected for the initial random access channel message transmission from the first set of random access channel resources or the second set of random access channel resources based on a first random selection that is weighted according to the first probability. In some examples, to support receiving the random access selection information, the RACH resource selection manager 830 is capable of, configured to, or operable to support a means for a second random access channel resource is selected for the retransmission of the random access channel message from the first set of random access channel resources or the second set of random access channel resources based on a second random selection that is weighted according to the second probability.

In some examples, to support receiving the random access selection information, the RACH configuration manager 825 is capable of, configured to, or operable to support a means for receiving a first probability associated with a first beam index that is associated with a first subset of the first set of random access channel resources and a second subset of the second set of random access channel resources. In some examples, to support receiving the random access selection information, the RACH configuration manager 825 is capable of, configured to, or operable to support a means for receiving a second probability associated with a second beam index that is associated with a third subset of the first set of random access channel resources and a fourth subset of the second set of random access channel resources. In some examples, to support receiving the random access selection information, the RACH resource selection manager 830 is capable of, configured to, or operable to support a means for where the first beam index or the second beam index is selected based on a channel measurement of reference signals associated with each beam index, and the respective first probability or second probability is used to determine whether the first random access channel resource is selected from the first set of random access channel resources or the second set of random access channel resources.

In some examples, to support receiving the random access selection information, the RSRP threshold manager 840 is capable of, configured to, or operable to support a means for receiving a first reference signal receive power (RSRP) threshold value associated with the first set of random access channel resources and a second RSRP threshold value associated with the second set of random access channel resources. In some examples, to support receiving the random access selection information, the RACH resource selection manager 830 is capable of, configured to, or operable to support a means for where the first random access channel resource can be selected from a respective set of random access channel resources when a measured RSRP value is greater than or equal to the RSRP threshold value associated with the respective set of random access channel resources. In some examples, the second RSRP threshold value is larger than the first RSRP threshold value. In some examples, the first RSRP threshold value is larger than the second RSRP threshold value.

In some examples, to support receiving the random access selection information, the RACH configuration manager 825 is capable of, configured to, or operable to support a means for receiving a probability value associated with the first set of random access channel resources and the second set of random access channel resources. In some examples, to support receiving the random access selection information, the RSRP threshold manager 840 is capable of, configured to, or operable to support a means for receiving a reference signal receive power (RSRP) threshold value associated with the second set of random access channel resources. In some examples, to support receiving the random access selection information, the RSRP threshold manager 840 is capable of, configured to, or operable to support a means for adjusting the RSRP threshold value based on the probability value to generate an adjusted RSRP threshold value. In some examples, to support receiving the random access selection information, the RACH resource selection manager 830 is capable of, configured to, or operable to support a means for where the first random access channel resource is selected from the second set of random access channel resources based on a measured RSRP value being greater than or equal to the adjusted RSRP threshold value.

In some examples, the random access selection information is received in one or more of system information, radio resource control information, or signaling that configures the second set of random access channel resources and that indicates one or more specified selection parameters. In some examples, the random access selection information is received in a downlink control information transmission that activates the second set of random access channel resources.

In some examples, the random access selection information includes a set of bits that indicate at least a first parameter of the one or more parameters for random access channel resource selection, and where the first parameter is indicated through a direct mapping to a real number by quantization over a maximum possible value of the first parameter, or through a mapping between different bit values and different values of the first parameter.

In some examples, the first random access channel resource is associated with a first subset of random access occasions of the second set of random access channel resources, and the RACH resource selection manager 830 is capable of, configured to, or operable to support a means for determining that a random access occasion of the first subset of random access occasions is not present within a first association period during which the first SSB is associated with the first subset of random access occasions. In some examples, the first random access channel resource is associated with a first subset of random access occasions of the second set of random access channel resources, and the RACH resource selection manager 830 is capable of, configured to, or operable to support a means for deferring transmission of the first random access channel message until a subsequent association period that does include a random access occasion of the first subset of random access occasions, or transmitting the first random access channel message in a random access channel resource of the first set of random access channel resources.

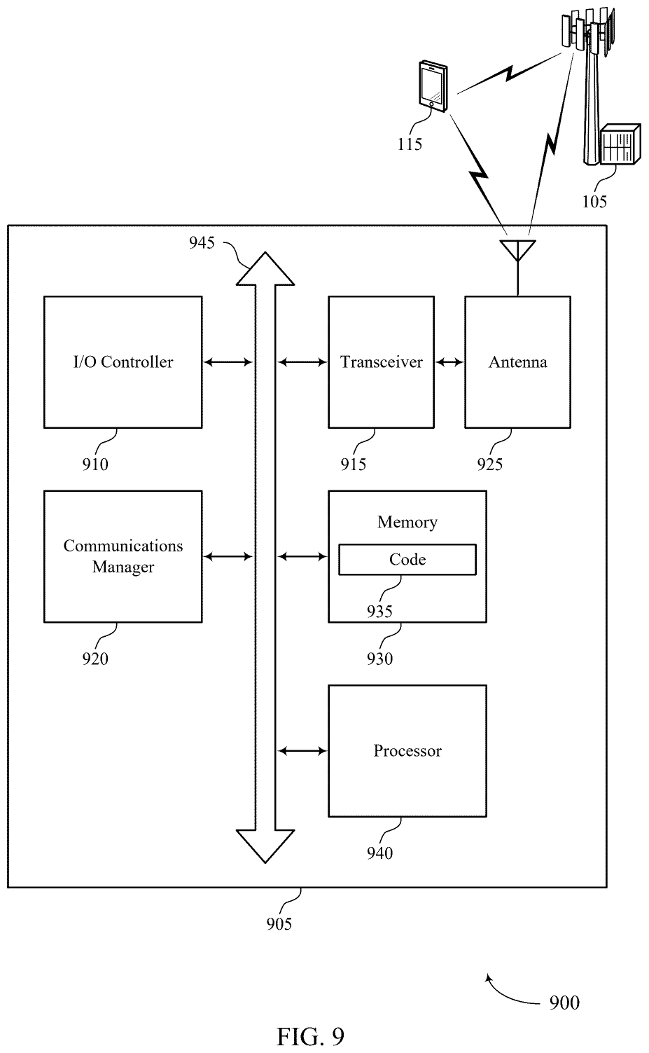

FIG. 9 shows a diagram of a system 900 including a device 905 that supports techniques for random access resource selection in wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for random access resource selection in wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period. The communications manager 920 is capable of, configured to, or operable to support a means for selecting a first random access channel resource from one of the first set of random access channel resources or the second set of random access channel resources based on the random-access selection information. The communications manager 920 is capable of, configured to, or operable to support a means for transmitting a first random access channel message via the first random access channel resource.

By including or configuring the communications manager 920 in accordance with examples as described herein, the device 905 may support techniques for selection of additional RACH resources by UEs that are capable of using such resources, while providing a baseline or legacy set of RACH resources that are available for UEs that do not have such capability. Such techniques may allow for power reduction techniques to be implemented by the network, as well as steering of UEs to use different RACH resources, which may enhance network flexibility and management of RACH resources, reduce latency associated with random access messages, and enhance network reliability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for random access resource selection in wireless communications as described herein, or the at least one processor 940 and the at least one memory 930 may be otherwise configured to, individually or collectively, perform or support such operations.

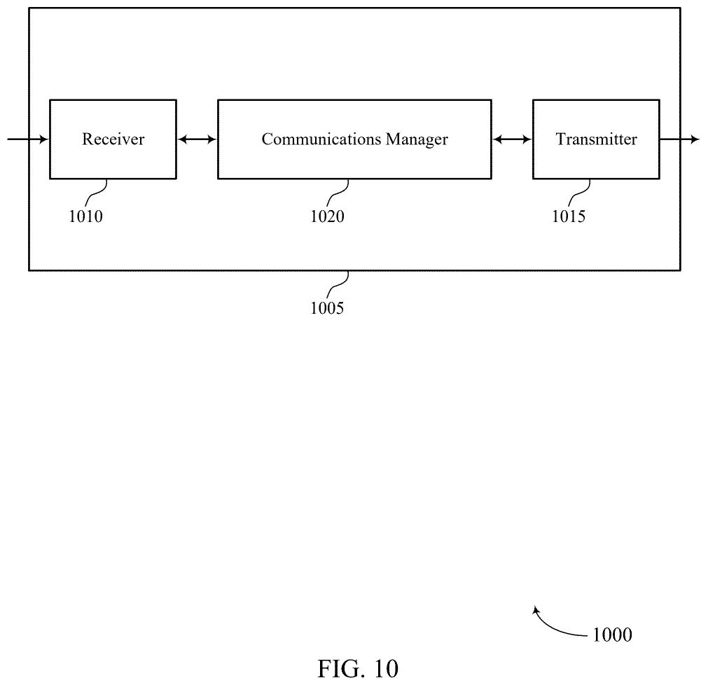

FIG. 10 shows a block diagram 1000 of a device 1005 that supports techniques for random access resource selection in wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for random access resource selection in wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period. The communications manager 1020 is capable of, configured to, or operable to support a means for outputting the random access selection information for transmission to one or more UEs. The communications manager 1020 is capable of, configured to, or operable to support a means for obtaining one or more random access channel messages via one or more of the first set of random access channel resources and the second set of random access channel resources.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for selection of additional RACH resources by UEs that are capable of using such resources, while providing a baseline or legacy set of RACH resources that are available for UEs that do not have such capability. Such techniques may allow for power reduction techniques to be implemented by the network, as well as steering of UEs to use different RACH resources, which may enhance network flexibility and management of RACH resources, reduce latency associated with random access messages, and enhance network reliability.

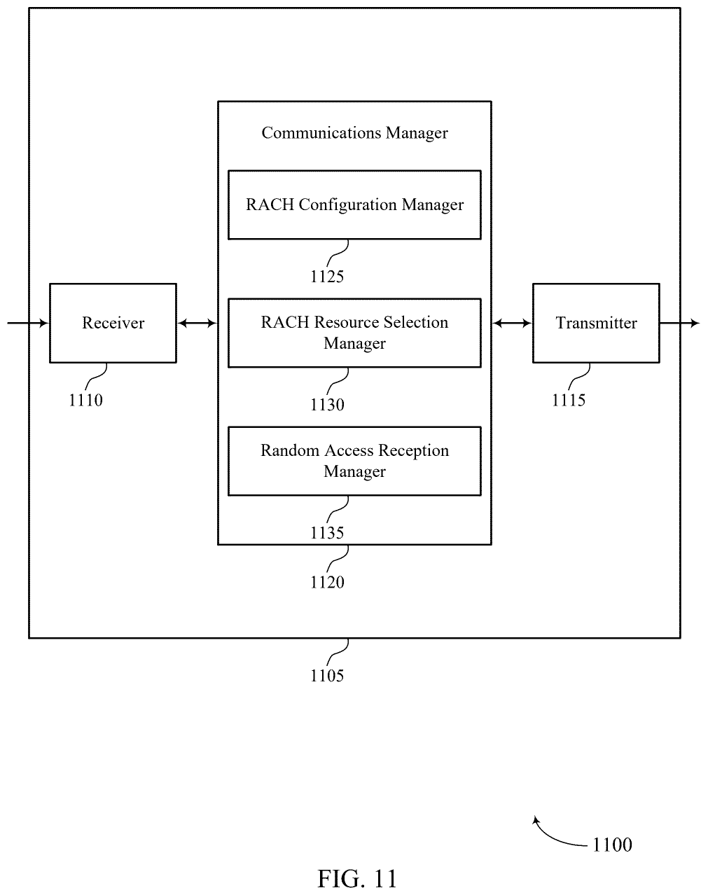

FIG. 11 shows a block diagram 1100 of a device 1105 that supports techniques for random access resource selection in wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for random access resource selection in wireless communications as described herein. For example, the communications manager 1120 may include a RACH configuration manager 1125, a RACH resource selection manager 1130, a random access reception manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The RACH configuration manager 1125 is capable of, configured to, or operable to support a means for determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period. The RACH resource selection manager 1130 is capable of, configured to, or operable to support a means for outputting the random access selection information for transmission to one or more UEs. The random access reception manager 1135 is capable of, configured to, or operable to support a means for obtaining one or more random access channel messages via one or more of the first set of random access channel resources and the second set of random access channel resources.

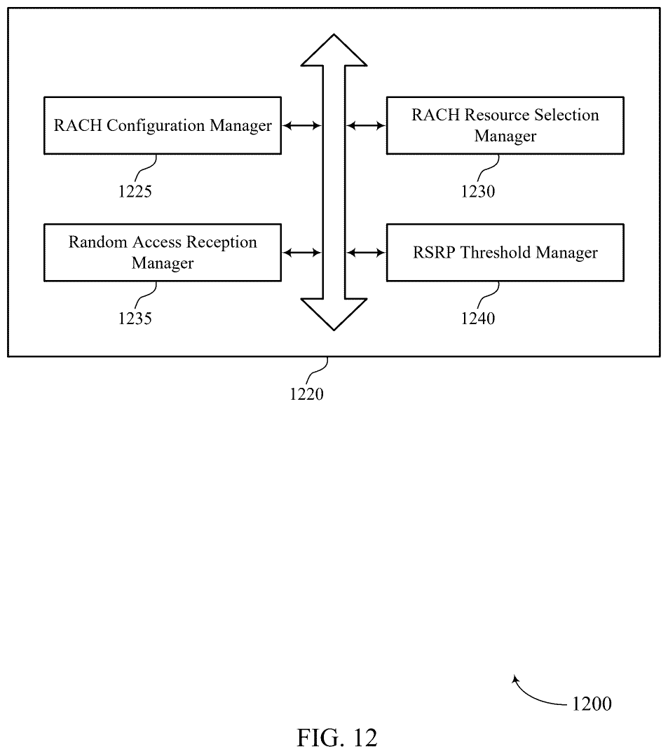

FIG. 12 shows a block diagram 1200 of a communications manager 1220 that supports techniques for random access resource selection in wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for random access resource selection in wireless communications as described herein. For example, the communications manager 1220 may include a RACH configuration manager 1225, a RACH resource selection manager 1230, a random access reception manager 1235, an RSRP threshold manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The RACH configuration manager 1225 is capable of, configured to, or operable to support a means for determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period. The RACH resource selection manager 1230 is capable of, configured to, or operable to support a means for outputting the random access selection information for transmission to one or more UEs. The random access reception manager 1235 is capable of, configured to, or operable to support a means for obtaining one or more random access channel messages via one or more of the first set of random access channel resources and the second set of random access channel resources.

In some examples, to support determining the random access selection information, the RACH configuration manager 1225 is capable of, configured to, or operable to support a means for determining a probability associated with the first set of random access channel resources and the second set of random access channel resources, and where the first random access channel resource is configured to be selected from the first set of random access channel resources or the second set of random access channel resources based on a random selection that is weighted according to the probability.

In some examples, to support determining the random access selection information, the RACH configuration manager 1225 is capable of, configured to, or operable to support a means for determining a first probability associated with the first set of random access channel resources and the second set of random access channel resources for an initial random access channel message transmission and a second probability associated with the first set of random access channel resources and the second set of random access channel resources for a retransmission of the random access channel message, and where. In some examples, to support determining the random access selection information, the RACH resource selection manager 1230 is capable of, configured to, or operable to support a means for the first random access channel resource is configured to be selected for the initial random access channel message transmission from the first set of random access channel resources or the second set of random access channel resources based on a first random selection that is weighted according to the first probability. In some examples, to support determining the random access selection information, the RACH resource selection manager 1230 is capable of, configured to, or operable to support a means for a second random access channel resource is configured to be selected for the retransmission of the random access channel message from the first set of random access channel resources or the second set of random access channel resources based on a second random selection that is weighted according to the second probability.

In some examples, to support determining the random access selection information, the RACH configuration manager 1225 is capable of, configured to, or operable to support a means for determining a first probability associated with a first beam index that is associated with a first subset of the first set of random access channel resources and a second subset of the second set of random access channel resources. In some examples, to support determining the random access selection information, the RACH configuration manager 1225 is capable of, configured to, or operable to support a means for determining a second probability associated with a second beam index that is associated with a third subset of the first set of random access channel resources and a fourth subset of the second set of random access channel resources. In some examples, to support determining the random access selection information, the RACH resource selection manager 1230 is capable of, configured to, or operable to support a means for where the first beam index or the second beam index is configured to be selected based on a channel measurement of reference signals associated with each beam index, and the respective first probability or second probability is used to determine whether the first random access channel resource is selected from the first set of random access channel resources or the second set of random access channel resources.

In some examples, to support determining the random access selection information, the RSRP threshold manager 1240 is capable of, configured to, or operable to support a means for determining a first reference signal receive power (RSRP) threshold value associated with the first set of random access channel resources and a second RSRP threshold value associated with the second set of random access channel resources. In some examples, to support determining the random access selection information, the RACH resource selection manager 1230 is capable of, configured to, or operable to support a means for where the first random access channel resource is configured to be selected from a respective set of random access channel resources when a measured RSRP value is greater than or equal to the RSRP threshold value associated with the respective set of random access channel resources. In some examples, the second RSRP threshold value is larger than the first RSRP threshold value. In some examples, the first RSRP threshold value is larger than the second RSRP threshold value.

In some examples, to support determining the random access selection information, the RACH configuration manager 1225 is capable of, configured to, or operable to support a means for determining a probability value associated with the first set of random access channel resources and the second set of random access channel resources. In some examples, to support determining the random access selection information, the RSRP threshold manager 1240 is capable of, configured to, or operable to support a means for determining a reference signal receive power (RSRP) threshold value associated with the second set of random access channel resources. In some examples, to support determining the random access selection information, the RSRP threshold manager 1240 is capable of, configured to, or operable to support a means for configuring the RSRP threshold value to be adjusted based on the probability value to generate an adjusted RSRP threshold value. In some examples, to support determining the random access selection information, the RACH resource selection manager 1230 is capable of, configured to, or operable to support a means for where the first random access channel resource is configured to be selected from the second set of random access channel resources based on a measured RSRP value being greater than or equal to the adjusted RSRP threshold value.

In some examples, the random access selection information is transmitted in one or more of system information, radio resource control information, or signaling that configures the second set of random access channel resources and that indicates one or more specified selection parameters.

In some examples, the random access selection information is transmitted in a downlink control information transmission that activates the second set of random access channel resources.

In some examples, the random access selection information includes a set of bits that indicate at least a first parameter for random access channel resource selection, and where the first parameter is indicated through a direct mapping to a real number by quantization over a maximum possible value of the first parameter, or through a mapping between different bit values and different values of the first parameter.

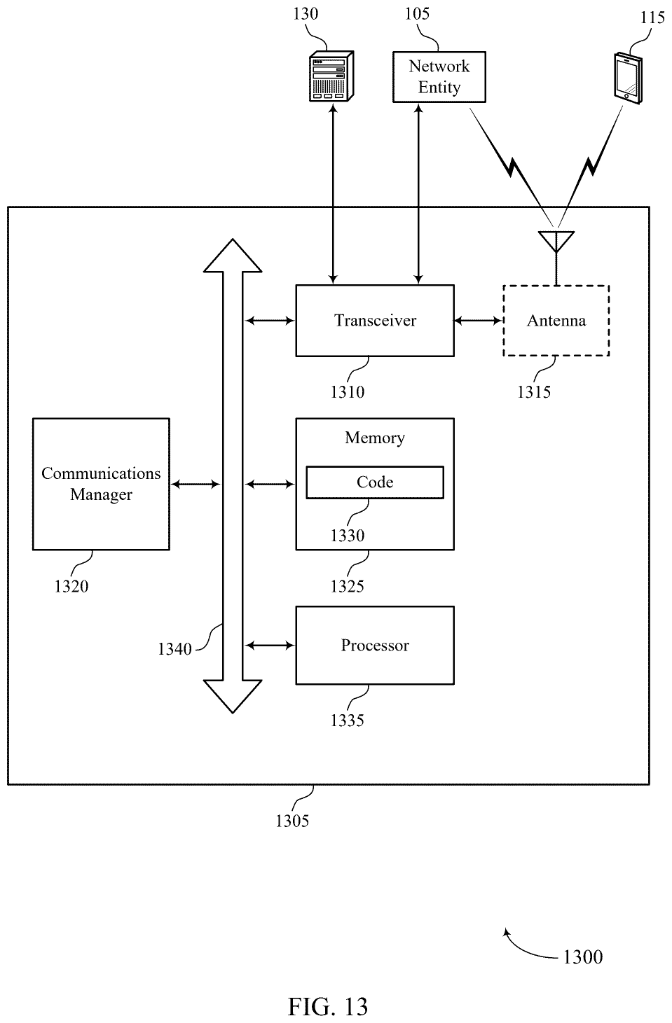

FIG. 13 shows a diagram of a system 1300 including a device 1305 that supports techniques for random access resource selection in wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for random access resource selection in wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period. The communications manager 1320 is capable of, configured to, or operable to support a means for outputting the random access selection information for transmission to one or more UEs. The communications manager 1320 is capable of, configured to, or operable to support a means for obtaining one or more random access channel messages via one or more of the first set of random access channel resources and the second set of random access channel resources.

By including or configuring the communications manager 1320 in accordance with examples as described herein, the device 1305 may support techniques for selection of additional RACH resources by UEs that are capable of using such resources, while providing a baseline or legacy set of RACH resources that are available for UEs that do not have such capability. Such techniques may allow for power reduction techniques to be implemented by the network, as well as steering of UEs to use different RACH resources, which may enhance network flexibility and management of RACH resources, reduce latency associated with random access messages, and enhance network reliability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for random access resource selection in wireless communications as described herein, or the at least one processor 1335 and the at least one memory 1325 may be otherwise configured to, individually or collectively, perform or support such operations.

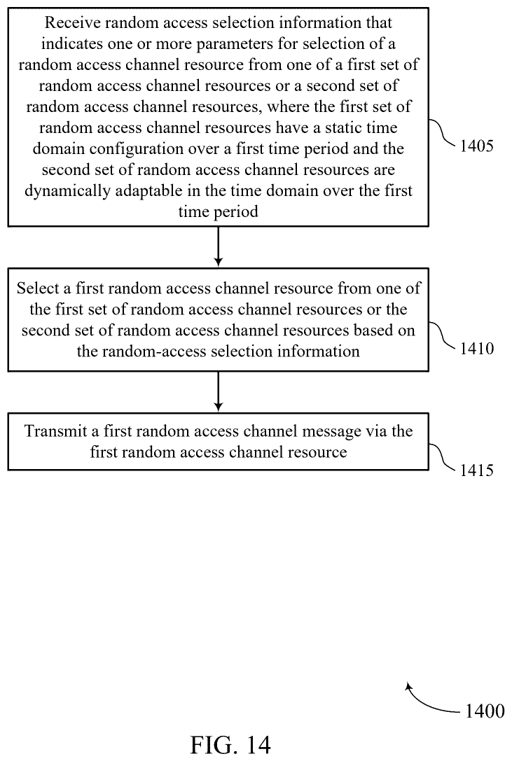

FIG. 14 shows a flowchart illustrating a method 1400 that supports techniques for random access resource selection in wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving random access selection information that indicates one or more parameters for selection of a random access channel resource from one of a first set of random access channel resources or a second set of random access channel resources, where the first set of random access channel resources have a static time domain configuration over a first time period and the second set of random access channel resources are dynamically adaptable in the time domain over the first time period. The operations of 1405 may be performed in accordance with examples as disclosed herein. In some examples, aspects of the operations of 1405 may be performed by a RACH configuration manager 825 as described with reference to FIG. 8.

At 1410, the method may include selecting a first random access channel resource from one of the first set of random access channel resources or the second set of random access channel resources based on the random-access selection information. The operations of 1410 may be performed in accordance with examples as disclosed herein. In some examples, aspects of the operations of 1410 may be performed by a RACH resource selection manager 830 as described with reference to FIG. 8.

At 1415, the method may include transmitting a first random access channel message via the first random access channel resource. The operations of 1415 may be performed in accordance with examples as disclosed herein. In some examples, aspects of the operations of 1415 may be performed by a random access transmission manager 835 as described with reference to FIG. 8.

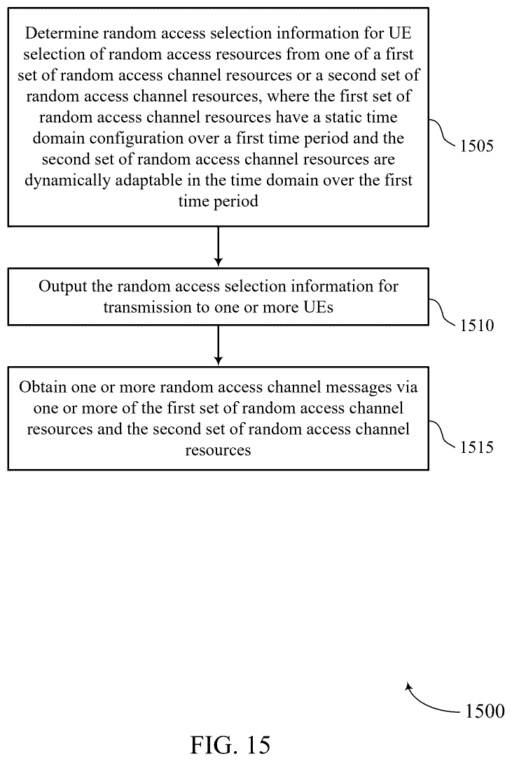

FIG. 15 shows a flowchart illustrating a method 1500 that supports techniques for random access resource selection in wireless communications in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include determining random access selection information for UE selection of random access resources from one of a first set of random access channel resources or a second set of random access channel resources, where the first set of random access channel resources have a static time domain configuration over a first time period and the second set of random access channel resources are dynamically adaptable in the time domain over the first time period. The operations of 1505 may be performed in accordance with examples as disclosed herein. In some examples, aspects of the operations of 1505 may be performed by a RACH configuration manager 1225 as described with reference to FIG. 12.

At 1510, the method may include outputting the random access selection information for transmission to one or more UEs. The operations of 1510 may be performed in accordance with examples as disclosed herein. In some examples, aspects of the operations of 1510 may be performed by a RACH resource selection manager 1230 as described with reference to FIG. 12.

At 1515, the method may include obtaining one or more random access channel messages via one or more of the first set of random access channel resources and the second set of random access channel resources. The operations of 1515 may be performed in accordance with examples as disclosed herein. In some examples, aspects of the operations of 1515 may be performed by a random access reception manager 1235 as described with reference to FIG. 12.

The following provides an overview of aspects of the present disclosure:

Aspect 1: A method for wireless communications at a UE, comprising: receiving random access selection information that indicates one or more parameters for selection of a random access channel resource from one of a first set of random access channel resources or a second set of random access channel resources, wherein the first set of random access channel resources have a static time domain configuration over a first time period and the second set of random access channel resources are dynamically adaptable in the time domain over the first time period; selecting a first random access channel resource from one of the first set of random access channel resources or the second set of random access channel resources based at least in part on the random-access selection information; and transmitting a first random access channel message via the first random access channel resource.

Aspect 2: The method of aspect 1, wherein the receiving the random access selection information comprises: receiving a probability associated with the first set of random access channel resources and the second set of random access channel resources, and wherein the first random access channel resource is selected from the first set of random access channel resources or the second set of random access channel resources based on a random selection that is weighted according to the probability.

Aspect 3: The method of any of aspects 1 through 2, wherein the receiving the random access selection information comprises: receiving a first probability associated with the first set of random access channel resources and the second set of random access channel resources for an initial random access channel message transmission and a second probability associated with the first set of random access channel resources and the second set of random access channel resources for a retransmission of the random access channel message, and wherein: the first random access channel resource is selected for the initial random access channel message transmission from the first set of random access channel resources or the second set of random access channel resources based on a first random selection that is weighted according to the first probability, and a second random access channel resource is selected for the retransmission of the random access channel message from the first set of random access channel resources or the second set of random access channel resources based on a second random selection that is weighted according to the second probability.

Aspect 4: The method of any of aspects 1 through 3, wherein the receiving the random access selection information comprises: receiving a first probability associated with a first beam index that is associated with a first subset of the first set of random access channel resources and a second subset of the second set of random access channel resources; and receiving a second probability associated with a second beam index that is associated with a third subset of the first set of random access channel resources and a fourth subset of the second set of random access channel resources, wherein the first beam index or the second beam index is selected based at least in part on a channel measurement of reference signals associated with each beam index, and the respective first probability or second probability is used to determine whether the first random access channel resource is selected from the first set of random access channel resources or the second set of random access channel resources.

Aspect 5: The method of any of aspects 1 through 4, wherein the receiving the random access selection information comprises: receiving a first reference signal receive power (RSRP) threshold value associated with the first set of random access channel resources and a second RSRP threshold value associated with the second set of random access channel resources, wherein the first random access channel resource can be selected from a respective set of random access channel resources when a measured RSRP value is greater than or equal to the RSRP threshold value associated with the respective set of random access channel resources.

Aspect 6: The method of aspect 5, wherein the second RSRP threshold value is larger than the first RSRP threshold value.

Aspect 7: The method of any of aspects 5 through 6, wherein the first RSRP threshold value is larger than the second RSRP threshold value.

Aspect 8: The method of any of aspects 1 through 7, wherein the receiving the random access selection information comprises: receiving a probability value associated with the first set of random access channel resources and the second set of random access channel resources; receiving a reference signal receive power (RSRP) threshold value associated with the second set of random access channel resources; and adjusting the RSRP threshold value based at least in part on the probability value to generate an adjusted RSRP threshold value, wherein the first random access channel resource is selected from the second set of random access channel resources based at least in part on a measured RSRP value being greater than or equal to the adjusted RSRP threshold value.

Aspect 9: The method of any of aspects 1 through 8, wherein the random access selection information is received in one or more of system information, radio resource control information, or signaling that configures the second set of random access channel resources and that indicates one or more specified selection parameters.

Aspect 10: The method of any of aspects 1 through 9, wherein the random access selection information is received in a downlink control information transmission that activates the second set of random access channel resources.

Aspect 11: The method of any of aspects 1 through 10, wherein the random access selection information includes a set of bits that indicate at least a first parameter of the one or more parameters for random access channel resource selection, and wherein the first parameter is indicated through a direct mapping to a real number by quantization over a maximum possible value of the first parameter, or through a mapping between different bit values and different values of the first parameter.

Aspect 12: The method of any of aspects 1 through 11, wherein the first random access channel resource is associated with a first subset of random access occasions of the second set of random access channel resources, the first subset of random access occasions associated with a first synchronization signal block (SSB), and wherein the method further comprises: determining that a random access occasion of the first subset of random access occasions is not present within a first association period during which the first SSB is associated with the first subset of random access occasions; and deferring transmission of the first random access channel message until a subsequent association period that does include a random access occasion of the first subset of random access occasions, or transmitting the first random access channel message in a random access channel resource of the first set of random access channel resources.

Aspect 13: A method for wireless communications at a network entity, comprising: determining random access selection information for UE selection of random access resources from one of a first set of random access channel resources or a second set of random access channel resources, wherein the first set of random access channel resources have a static time domain configuration over a first time period and the second set of random access channel resources are dynamically adaptable in the time domain over the first time period; outputting the random access selection information for transmission to one or more UEs; and obtaining one or more random access channel messages via one or more of the first set of random access channel resources and the second set of random access channel resources.

Aspect 14: The method of aspect 13, wherein the determining the random access selection information comprises: determining a probability associated with the first set of random access channel resources and the second set of random access channel resources, and wherein the first random access channel resource is configured to be selected from the first set of random access channel resources or the second set of random access channel resources based on a random selection that is weighted according to the probability.

Aspect 15: The method of any of aspects 13 through 14, wherein the determining the random access selection information comprises: determining a first probability associated with the first set of random access channel resources and the second set of random access channel resources for an initial random access channel message transmission and a second probability associated with the first set of random access channel resources and the second set of random access channel resources for a retransmission of the random access channel message, and wherein: the first random access channel resource is configured to be selected for the initial random access channel message transmission from the first set of random access channel resources or the second set of random access channel resources based on a first random selection that is weighted according to the first probability, and a second random access channel resource is configured to be selected for the retransmission of the random access channel message from the first set of random access channel resources or the second set of random access channel resources based on a second random selection that is weighted according to the second probability.

Aspect 16: The method of any of aspects 13 through 15, wherein the determining the random access selection information comprises: determining a first probability associated with a first beam index that is associated with a first subset of the first set of random access channel resources and a second subset of the second set of random access channel resources; and determining a second probability associated with a second beam index that is associated with a third subset of the first set of random access channel resources and a fourth subset of the second set of random access channel resources, wherein the first beam index or the second beam index is configured to be selected based at least in part on a channel measurement of reference signals associated with each beam index, and the respective first probability or second probability is used to determine whether the first random access channel resource is selected from the first set of random access channel resources or the second set of random access channel resources.

Aspect 17: The method of any of aspects 13 through 16, wherein the determining the random access selection information comprises: determining a first reference signal receive power (RSRP) threshold value associated with the first set of random access channel resources and a second RSRP threshold value associated with the second set of random access channel resources, wherein the first random access channel resource is configured to be selected from a respective set of random access channel resources when a measured RSRP value is greater than or equal to the RSRP threshold value associated with the respective set of random access channel resources.

Aspect 18: The method of aspect 17, wherein the second RSRP threshold value is larger than the first RSRP threshold value.

Aspect 19: The method of any of aspects 17 through 18, wherein the first RSRP threshold value is larger than the second RSRP threshold value.

Aspect 20: The method of any of aspects 13 through 19, wherein the determining the random access selection information comprises: determining a probability value associated with the first set of random access channel resources and the second set of random access channel resources; determining a reference signal receive power (RSRP) threshold value associated with the second set of random access channel resources; and configuring the RSRP threshold value to be adjusted based at least in part on the probability value to generate an adjusted RSRP threshold value, wherein the first random access channel resource is configured to be selected from the second set of random access channel resources based at least in part on a measured RSRP value being greater than or equal to the adjusted RSRP threshold value.

Aspect 21: The method of any of aspects 13 through 20, wherein the random access selection information is transmitted in one or more of system information, radio resource control information, or signaling that configures the second set of random access channel resources and that indicates one or more specified selection parameters.

Aspect 22: The method of any of aspects 13 through 21, wherein the random access selection information is transmitted in a downlink control information transmission that activates the second set of random access channel resources.

Aspect 23: The method of any of aspects 13 through 22, wherein the random access selection information includes a set of bits that indicate at least a first parameter for random access channel resource selection, and wherein the first parameter is indicated through a direct mapping to a real number by quantization over a maximum possible value of the first parameter, or through a mapping between different bit values and different values of the first parameter.

Aspect 24: A UE for wireless communications, comprising one or more memories storing processor-executable code, and one or more processors coupled with the one or more memories and individually or collectively operable to execute the code to cause the UE to perform a method of any of aspects 1 through 12.

Aspect 25: A UE for wireless communications, comprising at least one means for performing a method of any of aspects 1 through 12.

Aspect 26: A non-transitory computer-readable medium storing code for wireless communications, the code comprising instructions executable by one or more processors to perform a method of any of aspects 1 through 12.

Aspect 27: A network entity for wireless communications, comprising one or more memories storing processor-executable code, and one or more processors coupled with the one or more memories and individually or collectively operable to execute the code to cause the network entity to perform a method of any of aspects 13 through 23.

Aspect 28: A network entity for wireless communications, comprising at least one means for performing a method of any of aspects 13 through 23.

Aspect 29: A non-transitory computer-readable medium storing code for wireless communications, the code comprising instructions executable by one or more processors to perform a method of any of aspects 13 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive random access selection information that indicates one or more parameters for selection of a random access channel resource from one of a first set of random access channel resources or a second set of random access channel resources, wherein the first set of random access channel resources have a static time domain configuration over a first time period and the second set of random access channel resources are dynamically adaptable in the time domain over the first time period;
select a first random access channel resource from one of the first set of random access channel resources or the second set of random access channel resources based at least in part on the random-access selection information; and
transmit a first random access channel message via the first random access channel resource.

2. The UE of claim 1, wherein, to receive the random access selection information, the one or more processors are individually or collectively operable to execute the code to cause the UE to:
receive a probability associated with the first set of random access channel resources and the second set of random access channel resources, and wherein the first random access channel resource is selected from the first set of random access channel resources or the second set of random access channel resources based on a random selection that is weighted according to the probability.

3. The UE of claim 1, wherein, to receive the random access selection information, the one or more processors are individually or collectively operable to execute the code to cause the UE to:
receive a first probability associated with the first set of random access channel resources and the second set of random access channel resources for an initial random access channel message transmission and a second probability associated with the first set of random access channel resources and the second set of random access channel resources for a retransmission of the random access channel message, and wherein:
the first random access channel resource be selected for the initial random access channel message transmission from the first set of random access channel resources or the second set of random access channel resources based on a first random selection that is weighted according to the first probability, and
a second random access channel resource be selected for the retransmission of the random access channel message from the first set of random access channel resources or the second set of random access channel resources based on a second random selection that is weighted according to the second probability.

4. The UE of claim 1, wherein, to receive the random access selection information, the one or more processors are individually or collectively operable to execute the code to cause the UE to:
receive a first probability associated with a first beam index that is associated with a first subset of the first set of random access channel resources and a second subset of the second set of random access channel resources; and
receive a second probability associated with a second beam index that is associated with a third subset of the first set of random access channel resources and a fourth subset of the second set of random access channel resources,
wherein the first beam index or the second beam index be selected based at least in part on a channel measurement of reference signals associated with each beam index, and the respective first probability or second probability is used to determine whether the first random access channel resource is selected from the first set of random access channel resources or the second set of random access channel resources.

5. The UE of claim 1, wherein, to receive the random access selection information, the one or more processors are individually or collectively operable to execute the code to cause the UE to:
receive a first reference signal receive power (RSRP) threshold value associated with the first set of random access channel resources and a second RSRP threshold value associated with the second set of random access channel resources,
wherein the first random access channel resource can be selected from a respective set of random access channel resources when a measured RSRP value is greater than or equal to the RSRP threshold value associated with the respective set of random access channel resources.

6. The UE of claim 5, wherein the second RSRP threshold value is larger than the first RSRP threshold value.

7. The UE of claim 5, wherein the first RSRP threshold value is larger than the second RSRP threshold value.

8. The UE of claim 1, wherein, to receive the random access selection information, the one or more processors are individually or collectively operable to execute the code to cause the UE to:
receive a probability value associated with the first set of random access channel resources and the second set of random access channel resources;
receive a reference signal receive power (RSRP) threshold value associated with the second set of random access channel resources; and
adjust the RSRP threshold value based at least in part on the probability value to generate an adjusted RSRP threshold value,
wherein the first random access channel resource be selected from the second set of random access channel resources based at least in part on a measured RSRP value being greater than or equal to the adjusted RSRP threshold value.

9. The UE of claim 1, wherein the random access selection information is received in one or more of system information, radio resource control information, or signaling that configures the second set of random access channel resources and that indicates one or more specified selection parameters.

10. The UE of claim 1, wherein the random access selection information is received in a downlink control information transmission that activates the second set of random access channel resources.

11. The UE of claim 1, wherein the random access selection information includes a set of bits that indicate at least a first parameter of the one or more parameters for random access channel resource selection, and wherein the first parameter is indicated through a direct mapping to a real number by quantization over a maximum possible value of the first parameter, or through a mapping between different bit values and different values of the first parameter.

12. The UE of claim 1, wherein the first random access channel resource is associated with a first subset of random access occasions of the second set of random access channel resources, and the one or more processors are individually or collectively further operable to execute the code to cause the UE to:
determine that a random access occasion of the first subset of random access occasions is not present within a first association period during which the first SSB is associated with the first subset of random access occasions; and
defer transmission of the first random access channel message until a subsequent association period that does include a random access occasion of the first subset of random access occasions, or transmitting the first random access channel message in a random access channel resource of the first set of random access channel resources.

13. A network entity, comprising:
one or more memories storing processor-executable code; and
one or more processors coupled with the one or more memories and individually or collectively operable to execute the code to cause the network entity to:
determine random access selection information for user equipment (UE) selection of random access resources from one of a first set of random access channel resources or a second set of random access channel resources, wherein the first set of random access channel resources have a static time domain configuration over a first time period and the second set of random access channel resources are dynamically adaptable in the time domain over the first time period;
output the random access selection information for transmission to one or more UEs; and
obtain one or more random access channel messages via one or more of the first set of random access channel resources and the second set of random access channel resources.

14. The network entity of claim 13, wherein, to determine the random access selection information, the one or more processors are individually or collectively operable to execute the code to cause the network entity to:
determine a probability associated with the first set of random access channel resources and the second set of random access channel resources, and wherein the first random access channel resource is configured to be selected from the first set of random access channel resources or the second set of random access channel resources based on a random selection that is weighted according to the probability.

15. The network entity of claim 13, wherein, to determine the random access selection information, the one or more processors are individually or collectively operable to execute the code to cause the network entity to:
determine a first probability associated with the first set of random access channel resources and the second set of random access channel resources for an initial random access channel message transmission and a second probability associated with the first set of random access channel resources and the second set of random access channel resources for a retransmission of the random access channel message, and wherein:
the first random access channel resource be configured to be selected for the initial random access channel message transmission from the first set of random access channel resources or the second set of random access channel resources based on a first random selection that is weighted according to the first probability, and
a second random access channel resource be configured to be selected for the retransmission of the random access channel message from the first set of random access channel resources or the second set of random access channel resources based on a second random selection that is weighted according to the second probability.

16. The network entity of claim 13, wherein, to determine the random access selection information, the one or more processors are individually or collectively operable to execute the code to cause the network entity to:
determine a first probability associated with a first beam index that is associated with a first subset of the first set of random access channel resources and a second subset of the second set of random access channel resources; and
determine a second probability associated with a second beam index that is associated with a third subset of the first set of random access channel resources and a fourth subset of the second set of random access channel resources,
wherein the first beam index or the second beam index be configured to be selected based at least in part on a channel measurement of reference signals associated with each beam index, and the respective first probability or second probability is used to determine whether the first random access channel resource is selected from the first set of random access channel resources or the second set of random access channel resources.

17. The network entity of claim 13, wherein, to determine the random access selection information, the one or more processors are individually or collectively operable to execute the code to cause the network entity to:
determine a first reference signal receive power (RSRP) threshold value associated with the first set of random access channel resources and a second RSRP threshold value associated with the second set of random access channel resources,
wherein the first random access channel resource be configured to be selected from a respective set of random access channel resources when a measured RSRP value is greater than or equal to the RSRP threshold value associated with the respective set of random access channel resources.

18. The network entity of claim 13, wherein, to determine the random access selection information, the one or more processors are individually or collectively operable to execute the code to cause the network entity to:
determine a probability value associated with the first set of random access channel resources and the second set of random access channel resources;
determine a reference signal receive power (RSRP) threshold value associated with the second set of random access channel resources; and
configure the RSRP threshold value to be adjusted based at least in part on the probability value to generate an adjusted RSRP threshold value,
wherein the first random access channel resource be configured to be selected from the second set of random access channel resources based at least in part on a measured RSRP value being greater than or equal to the adjusted RSRP threshold value.

19. The network entity of claim 13, wherein the random access selection information is transmitted in one or more of system information, radio resource control information, or signaling that configures the second set of random access channel resources and that indicates one or more specified selection parameters.

20. The network entity of claim 13, wherein the random access selection information is transmitted in a downlink control information transmission that activates the second set of random access channel resources.

21. The network entity of claim 13, wherein the random access selection information includes a set of bits that indicate at least a first parameter for random access channel resource selection, and wherein the first parameter is indicated through a direct mapping to a real number by quantization over a maximum possible value of the first parameter, or through a mapping between different bit values and different values of the first parameter.

22. A method for wireless communications at a user equipment (UE), comprising:
receiving random access selection information that indicates one or more parameters for selection of a random access channel resource from one of a first set of random access channel resources or a second set of random access channel resources, wherein the first set of random access channel resources have a static time domain configuration over a first time period and the second set of random access channel resources are dynamically adaptable in the time domain over the first time period;
selecting a first random access channel resource from one of the first set of random access channel resources or the second set of random access channel resources based at least in part on the random-access selection information; and
transmitting a first random access channel message via the first random access channel resource.

23. The method of claim 22, wherein the receiving the random access selection information comprises:
receiving a probability associated with the first set of random access channel resources and the second set of random access channel resources, and wherein the first random access channel resource is selected from the first set of random access channel resources or the second set of random access channel resources based on a random selection that is weighted according to the probability.

24. The method of claim 22, wherein the receiving the random access selection information comprises:
receiving a first probability associated with the first set of random access channel resources and the second set of random access channel resources for an initial random access channel message transmission and a second probability associated with the first set of random access channel resources and the second set of random access channel resources for a retransmission of the random access channel message, and wherein:
the first random access channel resource is selected for the initial random access channel message transmission from the first set of random access channel resources or the second set of random access channel resources based on a first random selection that is weighted according to the first probability, and
a second random access channel resource is selected for the retransmission of the random access channel message from the first set of random access channel resources or the second set of random access channel resources based on a second random selection that is weighted according to the second probability.

25. The method of claim 22, wherein the receiving the random access selection information comprises:
receiving a first probability associated with a first beam index that is associated with a first subset of the first set of random access channel resources and a second subset of the second set of random access channel resources; and
receiving a second probability associated with a second beam index that is associated with a third subset of the first set of random access channel resources and a fourth subset of the second set of random access channel resources,
wherein the first beam index or the second beam index is selected based at least in part on a channel measurement of reference signals associated with each beam index, and the respective first probability or second probability is used to determine whether the first random access channel resource is selected from the first set of random access channel resources or the second set of random access channel resources.

26. The method of claim 22, wherein the receiving the random access selection information comprises:
receiving a first reference signal receive power (RSRP) threshold value associated with the first set of random access channel resources and a second RSRP threshold value associated with the second set of random access channel resources,
wherein the first random access channel resource can be selected from a respective set of random access channel resources when a measured RSRP value is greater than or equal to the RSRP threshold value associated with the respective set of random access channel resources.

27. A method for wireless communications at a network entity, comprising:
determining random access selection information for user equipment (UE) selection of random access resources from one of a first set of random access channel resources or a second set of random access channel resources, wherein the first set of random access channel resources have a static time domain configuration over a first time period and the second set of random access channel resources are dynamically adaptable in the time domain over the first time period;
outputting the random access selection information for transmission to one or more UEs; and
obtaining one or more random access channel messages via one or more of the first set of random access channel resources and the second set of random access channel resources.

28. The method of claim 27, wherein the determining the random access selection information comprises:
determining a probability associated with the first set of random access channel resources and the second set of random access channel resources, and wherein the first random access channel resource is configured to be selected from the first set of random access channel resources or the second set of random access channel resources based on a random selection that is weighted according to the probability.

29. The method of claim 27, wherein the determining the random access selection information comprises:
determining a first probability associated with the first set of random access channel resources and the second set of random access channel resources for an initial random access channel message transmission and a second probability associated with the first set of random access channel resources and the second set of random access channel resources for a retransmission of the random access channel message, and wherein:
the first random access channel resource is configured to be selected for the initial random access channel message transmission from the first set of random access channel resources or the second set of random access channel resources based on a first random selection that is weighted according to the first probability, and
a second random access channel resource is configured to be selected for the retransmission of the random access channel message from the first set of random access channel resources or the second set of random access channel resources based on a second random selection that is weighted according to the second probability.

30. The method of claim 27, wherein the determining the random access selection information comprises:
determining a first probability associated with a first beam index that is associated with a first subset of the first set of random access channel resources and a second subset of the second set of random access channel resources; and
determining a second probability associated with a second beam index that is associated with a third subset of the first set of random access channel resources and a fourth subset of the second set of random access channel resources,
wherein the first beam index or the second beam index is configured to be selected based at least in part on a channel measurement of reference signals associated with each beam index, and the respective first probability or second probability is used to determine whether the first random access channel resource is selected from the first set of random access channel resources or the second set of random access channel resources.
